(19) United States
(12) Patent Application Publication
(10) Pub. No.: US 2022/0351624 A1
(43) Pub. Date: Nov. 3, 2022

(54) SYSTEM AND METHOD TO MANAGE FIRST AND LAST MILE CONNECTIVITY SERVICE OF A TRIP

(71) Applicant: Arual Siva MURUGAN. V, Chennai (IN)

(72) Inventors: Arul Siva Murugan. V, Chennai (IN); Muthuraja T, Chennai (IN)

(21) Appl. No.: 17/621,192

(22) PCT Filed: Jan. 28, 2020
(86) PCT No.: PCT/IB2020/050631

§ 371 Date: Dec. 20, 2021

(30) Foreign Application Priority Data
Dec. 13, 2019 (IN) 201941051806

(51) Int. Cl. G08G 1/00; G06Q 10/02; G06Q 50/30; H04W 4/021

(52) U.S. Cl. CPC G08G 1/202; G06Q 10/02; G06Q 50/30; H04W 4/021

(57) ABSTRACT

A system to manage first mile and last mile connectivity service of a trip is disclosed. The system includes a passenger request receiving subsystem to receive a request from at least one passenger for reserving at least one pickup vehicle; a pickup vehicle location subsystem to locate the at least one pickup vehicle in proximity to the pickup location; a passenger arrival identification subsystem to identify an arrival time of the at least one passenger at a source station, to predict an arrival time of the at least one passenger at a destination station, to quantize a predicted arrival time of the at least one passenger to a predefined time interval, to determine an arrival of the at least one passenger at the destination station; a passenger allocation subsystem to allocate at least one arrived passenger at the destination station to at least one drop vehicle.

### CROSS-REFERENCE

This application claims priority from a PCT application numbered PCT/IB2020/050631, field on Jan. 28, 2020 and titled “STEM AND METHOD TO MANAGE FIRST AND LAST MILE CONNECTIVITY SERVICE OF A TRIP”

### BACKGROUND

Embodiments of the present disclosure relate to a management system for a transportation service and more particularly to a system and a method to manage first mile and last mile connectivity service of a trip.

Transportation service refers to an operation of one or more vehicles for transporting goods or one or more passengers from one place to another. The transportation service is provided by using various means of transport which includes roadways, railways, airways or waterways. The transportation service through any of the means of the transport is provided to the one or more passengers by planning in advance or each time in accordance with travel demand of the one or more passengers who use such transportation services. Generally, the transportation service plan involves plans to be prepared after having received a request from a passenger, such as dispatching a taxi, in addition to preliminarily prepared plans such as railway or bus operation plans. Also, based on the transportation service plan, the first mile and the last mile connectivity of a trip is also planned in order to provide a complete transportation service. The first mile and the last mile connectivity service helps one or more daily passengers to commute from one place of the city to another using a public transportation service. Various systems are available which helps in managing the first mile and the last mile connectivity service of the trip to provide a hassle free service to the one or more daily passengers.

Conventionally, the systems available for managing the first mile and the last mile connectivity service includes provision of the first mile and the last mile connectivity service by allocation of the one or more vehicles to the one or more passengers from a source location to a source station based on a first come first serve approach. Also, such conventional systems utilise a concept of arrival time of the one or more passengers for the allocation of the one or more vehicles. However, such conventional systems predict the arrival time of the one or more passengers based on calculation of an estimated time of arrival. Moreover, such conventional systems ignore one or more factors such as demand of booking, peak hours of booking, similar destination location of the one or more passengers and the like for the allocation of the one or more vehicles. Furthermore, such conventional system is also unable to manage an arrangement for the allocation of the one or more vehicles for the one or more passengers.

Hence, there is a need for an improved system and a method to manage first mile and last mile connectivity service of a trip in order to address the aforementioned issues.

### BRIEF DESCRIPTION

In accordance with an embodiment of the present disclosure, a system to manage first and last mile connectivity service of a trip is disclosed. The system includes a passenger request receiving subsystem configured to receive a request from at least one passenger via an electronic device associated with the at least one passenger for reserving at least one pickup vehicle from a pickup location to a source station. The system also includes a pickup vehicle location subsystem operatively coupled to the passenger request receiving subsystem. The pickup vehicle location subsystem is configured to locate the at least one pickup vehicle in proximity to the pickup location of the at least one passenger for reservation based on a received request. The system also includes a passenger arrival identification subsystem operatively coupled to the vehicle location subsystem. The passenger arrival identification subsystem is configured to identify a present arrival time of the at least one passenger at the source station using at least one reserved pickup vehicle based on an estimated time arrival (ETA) calculation. The passenger arrival identification subsystem is also configured to predict an arrival time of the at least one passenger at a destination station upon analysis of an identified present arrival time of the at least one passenger and historical geographical location data associated with the at least one passenger using a predictive modelling technique. The passenger arrival identification subsystem is also configured to quantize a predicted arrival time of the at least one passenger to a predefined time interval based on a frequency of one or more transporters operating from the source station to reach the destination station. The passenger arrival identification subsystem is also configured to determine an arrival of the at least one passenger at the destination station based on a quantized arrival time information and reservation information associated with the at least one pickup vehicle. The system also includes a passenger allocation subsystem operatively coupled to the passenger arrival subsystem. The passenger allocation subsystem is configured to allocate at least one arrived passenger at the destination station to at least one drop vehicle available for reaching a drop location.

In accordance with another embodiment of the present disclosure, a method to manage first mile and last mile connectivity service of a trip is disclosed. The method includes receiving, by a passenger request receiving subsystem, a request from at least one passenger via an electronic device associated with the at least one passenger for reserving at least one pickup vehicle from a pickup location to a source station. The method also includes locating, by a pickup vehicle location subsystem, the at least one pickup vehicle in proximity to the pickup location of the at least one passenger for reservation based on a received request. The method also includes identifying, by a passenger arrival identification subsystem, a present arrival time of the at least one passenger at the source station travelled using at least one reserved pickup vehicle based on an estimated time arrival (ETA) calculation. The method also includes predicting, by the passenger arrival identification subsystem, an arrival time of the at least one passenger at a destination station upon analysis of an identified present arrival time of the at least one passenger and historical geographical location associated with the at least one passenger using a predictive modelling technique. The method also includes quantising, by the passenger arrival identification subsystem, a predicted arrival time of the at least one passenger to a predefined interval of time based on a frequency of one or more transporters operating from the source station to reach the destination station. The method also includes determining, by the passenger arrival identification subsystem, an arrival time of the at least one passenger at the destination station based on a quantized arrival time information and reservation information associated with the at least one pickup vehicle. The method also includes allocating, by a passenger allocation subsystem, at least one arrived passenger at the destination station to at least one drop vehicle available for reaching a drop location.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system to manage first and last mile connectivity service of a trip in accordance with an embodiment of the present disclosure;

FIG. 2 illustrates a schematic representation of an exemplary embodiment of a system to manage first and last mile connectivity service of a trip of FIG. 1 in accordance with an embodiment of the present disclosure;

FIG. 3 is a block diagram of a computer or a server in accordance with an embodiment of the present disclosure; and

FIG. 4 is a flow chart representing the steps involved in a method to manage first and last mile connectivity service of a trip of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system. and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises... a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method to manage first and last mile connectivity service of a trip. The system includes a passenger request receiving subsystem configured to receive a request from at least one passenger via an electronic device associated with the at least one passenger for reserving at least one pickup vehicle from a pickup location to a source station. The system also includes a pickup vehicle location subsystem operatively coupled to the passenger request receiving subsystem. The pickup vehicle location subsystem is configured to locate the at least one pickup vehicle in proximity to the pickup location of the at least one passenger for reservation based on a received request. The system also includes a passenger arrival identification subsystem operatively coupled to the vehicle location subsystem. The passenger arrival identification subsystem is configured to identify a present arrival time of the at least one passenger at the source station using at least one reserved pickup vehicle based on an estimated time arrival (ETA) calculation. The passenger arrival identification subsystem is also configured to predict an arrival time of the at least one passenger at a destination station upon analysis of an identified present arrival time of the at least one passenger and historical geographical location data associated with the at least one passenger using a predictive modelling technique. The passenger arrival identification subsystem is also configured to quantize a predicted arrival time of the at least one passenger to a predefined time interval based on a frequency of one or more transporters operating from the source station to reach the destination station. The passenger arrival identification subsystem is also configured to determine an arrival of the at least one passenger at the destination station based on a quantized arrival time information and reservation information associated with the at least one pickup vehicle. The system also includes a passenger allocation subsystem operatively coupled to the passenger arrival identification subsystem. The passenger allocation subsystem is configured to allocate at least one arrived passenger at the destination station to at least one drop vehicle available for reaching a drop location.

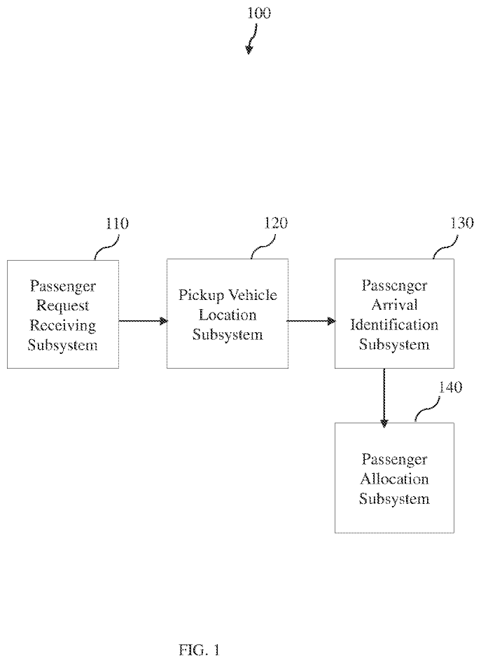

FIG. 1 is a block diagram of a system (100) to manage first and last mile connectivity service of a trip in accordance with an embodiment of the present disclosure. The system (100) includes a passenger request receiving subsystem (110) configured to receive a request from at least one passenger via an electronic device associated with the at least one passenger for reserving at least one pickup vehicle from a pickup location to a source station. As used herein, the term ‘pickup vehicle’ is defined as a vehicle for carrying passengers from a pickup point to another dropping point. In one embodiment, the pickup vehicle may include at least one of a taxi, a shuttle bus, a van, a motorbike or a combination thereof. Similarly, the term ‘pickup location’ is defined as the pickup point from where the at least one passenger is pickup by the pickup vehicle. In some embodiment, the request for reserving the at least one pickup vehicle may include reserving the pickup vehicle from the pickup location to the source station or from destination station to drop location based on passenger's requirement. Again, the term ‘source station’ used herein, is defined as a station nearest to the pickup location of the at least one passenger. In one embodiment, the source station may include at least one of a metro station, a suburban railway station, a tram station, a bus terminal, a ferry terminal or a combination thereof.

The system (100) also includes a pickup vehicle location subsystem (120) operatively coupled to the passenger request receiving subsystem (110). The pickup vehicle location subsystem (120) is configured to locate the at least one pickup vehicle in proximity to the pickup location of the at least one passenger for reservation based on a received request. In one embodiment, the pickup vehicle location subsystem is configured to create a geo-fence around the pickup location of the at least one passenger dynamically. In some embodiment, the pickup vehicle location subsystem is also configured to locate the at least one pickup vehicle for the reservation based on matching of geographical location coordinates corresponding to the at least one pickup vehicle with geo-fence coordinates corresponding to the at least one passenger. As used herein, the term ‘geo-fence’ is defined as a virtual perimeter created dynamically for a real-world geographic area.

The system (100) also includes a passenger arrival identification subsystem (130) operatively coupled to the vehicle location subsystem (120). The passenger arrival identification subsystem (130) is configured to identify a present arrival time of the at least one passenger travelled at the source station using at least one reserved pickup vehicle based on an estimated time arrival (ETA) calculation. The ETA is calculated based on a speed by which the at least one pickup vehicle has covered a predefined value of distance. The ETA for the pickup vehicle is calculated based on real-time travel time data fetched from an external service provider such as Google maps™ or MapMylndia™ using a third-party application programming interface (API). The time and distance to travel between two geo-locations are received using the third-party API and aggregated computations are done internally based on a requirement to reach the source station or a drop location.

The passenger arrival identification subsystem (130) is also configured to predict an arrival time of the at least one passenger at a destination station upon analysis of an identified present arrival time of the at least one passenger and historical geographical location data associated with the at least one passenger using a predictive modelling technique. The predictive modelling technique may include a machine learning modelling technique, wherein the predictive modelling technique predicts the arrival time of the at least one passenger based on statistical data obtained from real-time data and the historical geographical location data. In one embodiment, the historical geographical location data may include at least one of history details of geographical location travelled by the at least one passenger, historical details of geographical location where the at least one passenger took halt, historical details of the geographical location of a frequent arrival point of the at least one passenger and the like.

The passenger arrival identification subsystem (130) is also configured to quantize a predicted arrival time of the at least one passenger to a predefined time interval based on a frequency of one or more transporters operating from the source station to reach a destination station. In one embodiment, the one or more transporters may include at least one of a metro, a suburban rail, a tram, a bus, a motorboat or a combination thereof. In some embodiment, the predefined time interval may include one or more minutes in order to improve location accuracy, time of a handheld device associated with the at least one passenger and assignment of at least one drop vehicle for allocation. In such embodiment, the handheld device may include but not limited to a, a mobile phone, a tablet, a personal digital assistant (PDA) and the like.

The passenger arrival identification subsystem (130) is also configured to determine an arrival of the at least one passenger at the destination station based on a quantized arrival time information and reservation information associated with the at least one pickup vehicle. As used herein, the term ‘destination station’ is defined as a final and ending station where the one or more transporters upon operating from the source station reaches. In one embodiment, the reservation information may include but not limited to, passenger name, passenger contact number, details of at least one reserved pickup vehicle, driver details of the at least one reserved vehicle and the like.

The system (100) also includes a passenger allocation subsystem (140) operatively coupled to the passenger arrival identification subsystem (130). The passenger allocation subsystem (140) is configured to allocate at least one arrived passenger at the destination station to at least one drop vehicle available for reaching a drop location. As used herein, the term ‘drop vehicle’ is defined as a vehicle which is utilized to transfer the at least one passenger from the destination station to final drop location associated with the at least one passenger. Similarly, the term ‘drop location’ is defined as an end point wherein the at least one passenger reaches at an end of a trip or a journey. In one embodiment, the passenger allocation subsystem is configured to identify number of the at least one drop vehicle available at the destination station in real-time for allocation of the at least one arrived passenger based on the quantized arrival time of the at least one passenger. In some embodiment, the passenger allocation subsystem may also determine the drop location corresponding to the at least one arrived passenger using a geo-location modelling technique upon identification of the number of the at least one drop vehicle available and identification of the at least one passenger available at the destination station. In such embodiment, the passenger allocation subsystem may also regroup the at least one arrived passenger at the destination station based on a determined drop location corresponding to the at least one arrived passenger for separating a direction of travel upon allocation.

In a specific embodiment, the system (100) further includes a vehicle management subsystem (not shown in FIG.1) operatively coupled to the passenger arrival identification subsystem (130). In such embodiment, the vehicle management subsystem is configured to manage an availability of the at least one pick-up vehicle and the at least one drop vehicle for providing a transportation service based on historical usage data and a predicted weather forecast report.

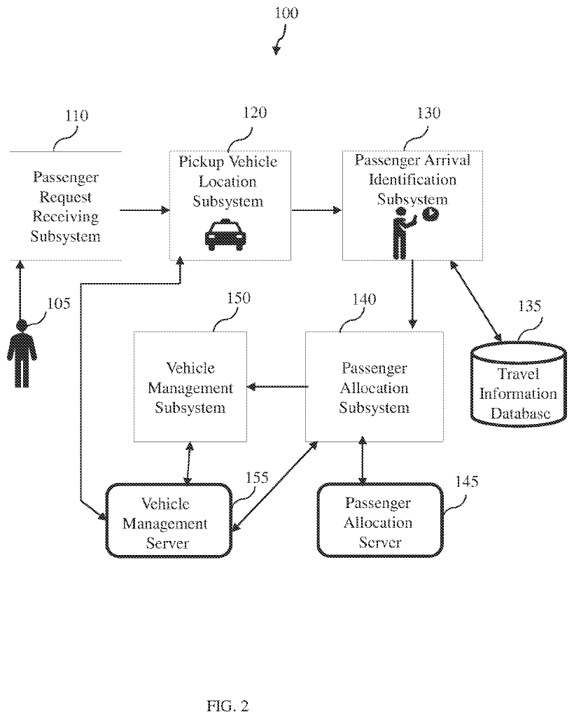

FIG. 2 illustrates a schematic representation of an exemplary embodiment of a system (100) to manage first and last mile connectivity service of a trip of FIG. 1 in accordance with an embodiment of the present disclosure. The system (100) helps in providing an end to end transportation service for daily commutation needs of one or more daily passengers using reliable public transportation. For example, let us assume, that a passenger ‘X’ (105) is daily passenger and travels from a place ‘A’ of a city to place ‘B’ using the public transportation service such as a metro train. Here, the place ‘A’ refers to a place of residence of the passenger ‘X’ (105) and the place ‘B’ refers to a working place of the passenger ‘X’ (105). Now, while starting a trip every day, the passenger ‘X’ (105) through an electronic handheld device sends a request for reservation of a pickup vehicle such as a cab. The pickup vehicle picks up the passenger ‘X’ (105) from a pickup location ‘I’ in proximity to the place ‘A’ in order to reach a nearby metro or a source station ‘M’ corresponding to the place ‘A’. The request sent by the passenger ‘X’ (105) is received by a passenger request receiving subsystem (110).

Upon receiving the request from the passenger ‘X’ (105), a pickup vehicle location subsystem (120) locates the pickup vehicle in proximity to the pickup location such as ‘I’ for reservation by creating a geo-fence around the pickup location of the passenger ‘X’ (105) dynamically. Also, the pickup vehicle location subsystem (120) locates the pickup vehicle for the reservation based on matching of geographical location coordinates corresponding to the pickup vehicle with geo-fence coordinates corresponding to the passenger ‘X’.

Again, the pickup vehicle location subsystem (120) also guarantees that the already picked up passenger prior to a request associated with the passenger ‘X’ (105) does not get delayed beyond a predefined threshold, wherein the predefined threshold includes a missing of maximum two metro trains. Even, the pickup vehicle location subsystem (120) also helps in making a deal for reservation of the pickup vehicle so that there is less chance of negotiation with drivers of the pickup vehicle.

Later upon confirmation of the reservation, the passenger ‘X’ (105) then utilizes a reserved pickup vehicle to reach the source station ‘M’. An arrival time of the passenger ‘X’ (105) at the source station such as ‘M’ travelled by using the reserved pickup vehicle is identified based on an estimated time arrival (ETA) calculation. Once, the present arrival time of the passenger ‘X’ (105) is identified by a passenger arrival identification subsystem (130), arrival time of the passenger ‘X’ (105) at a destination station ‘N’ in proximity to the place ‘B’ is predicted upon analysis of an identified present arrival time of the passenger ‘X’ (105) and historical geographical location data associated with the passenger ‘X’ (105) using a predictive modelling technique. Here, the historical geographical location data may include at least one of history details of geographical location travelled by the at least one passenger, historical details of geographical location where the at least one passenger took halt, historical details of the geographical location of a frequent arrival point of the at least one passenger and the like.

Again, the passenger arrival identification subsystem (130) also quantizes a predicted arrival time of the at least one passenger at the source station to a predefined time interval based on a frequency of one or more transporters operating from the source station ‘M’ to reach a destination station ‘N’. Here, quantization is done to improve location accuracy and time of the electronic handheld device associated with the passenger ‘X’ (105) as well as assignment of a drop vehicle allocation which may run at the same frequency as the metro train.

Later, an arrival of the passenger at the destination station ‘N’ is determined based on a quantized arrival time information and reservation information associated with the pickup vehicle by the passenger arrival identification subsystem (130). Here, the reservation information may include but not limited to, passenger name, passenger contact number, details of at least one reserved pickup vehicle, driver details of the at least one reserved vehicle and the like. The quantized arrival time information and the reservation information associated with the pickup vehicle is stored in a travel information database (135). Here, the travel information database is periodically updated based on the reservation information obtained from at least one passenger.

Upon identification of details of the passenger ‘X’ at the destination station ‘N’, an allocation of the passenger ‘X’ to a drop vehicle available for reaching a drop location ‘J’ within the place ‘B’ is done by a passenger allocation subsystem (140). Here, the allocation of the passenger ‘X’ is analyzed based on an identification of number of at least one drop vehicle available at the destination station ‘N’ in real-time for at least one arrived passenger based on the quantized arrival time of the at least one passenger. The drop location corresponding to the at least one arrived passenger is determined using a geo-location modelling technique upon identification of the number of the at least one drop vehicle available and identification of the at least one passenger available at the destination station. Also, the passenger allocation subsystem (140) regroups the at least one arrived passenger at the destination station based on a determined drop location corresponding to the at least one arrived passenger for separating a direction of travel.

Further, in case of demand or an unavailability of vehicle such as either the pickup vehicle or the drop vehicle, a vehicle management subsystem (150) manages an availability of the at least one pick up vehicle and the at least one drop vehicle for providing a first mile and last mile connectivity service based on historical usage data and a predicted weather forecast report. Data corresponding to the pickup vehicle and the drop vehicle based on a passenger request and vehicle's response is maintained in a vehicle management server (155) so that overall transportation service for a trip and first mile and last mile connectivity of the trip for the daily commuters are not hampered.

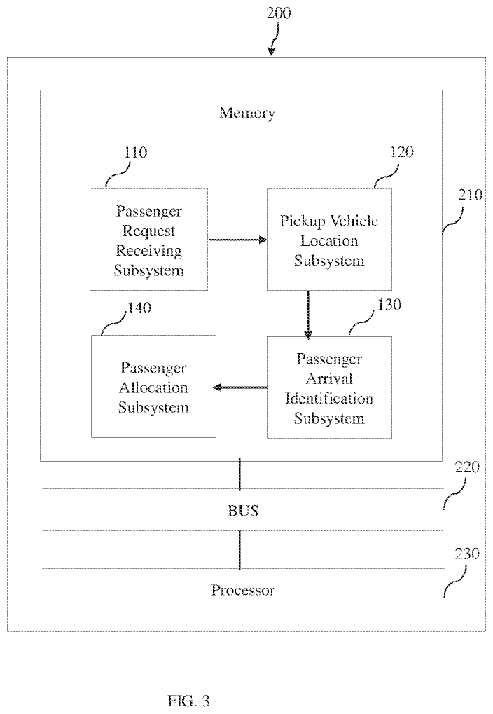

FIG. 3 is a block diagram of a computer or a server in accordance with an embodiment of the present disclosure. The server (200) includes processor(s) (230), and memory (210) operatively coupled to the bus (220).

The processor(s) (230), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (210) includes a plurality of subsystems stored in the form of executable program which instructs the processor (230) to perform the method steps illustrated in FIG. 1. The memory (210) is substantially similar to the system (100) of FIG.1. The memory (210) has following subsystems: a passenger request receiving subsystem (110), a pickup vehicle location subsystem (120), a passenger arrival identification subsystem (130) and a passenger allocation subsystem (140).

The passenger request receiving subsystem (110) is configured to receive a request from at least one passenger via an electronic device associated with the at least one passenger for reserving at least one pickup vehicle from a pickup location to a source station. The pickup vehicle location subsystem (120) is configured to locate the at least one pickup vehicle in proximity to the pickup location of the at least one passenger for reservation based on a received request. The passenger arrival identification subsystem (130) is configured to identify a present arrival time of the at least one passenger at the source station using at least one reserved pickup vehicle based on an estimated time arrival (ETA) calculation. The passenger arrival identification subsystem (130) is also configured to predict an arrival time of the at least one passenger at a destination station upon analysis of an identified present arrival time of the at least one passenger and historical geographical location data associated with the at least one passenger using a predictive modelling technique. The passenger arrival identification subsystem (130) is also configured to quantize a predicted arrival time of the at least one passenger to a predefined time interval based on a frequency of one or more transporters operating from the source station to reach the destination station. The passenger arrival identification subsystem (130) is also configured to determine an arrival of the at least one passenger at the destination station based on a quantized arrival time information and reservation information associated with the at least one pickup vehicle. The passenger allocation subsystem (140) is configured to allocate at least one arrived passenger at the destination station to at least one drop vehicle available for reaching a drop location.

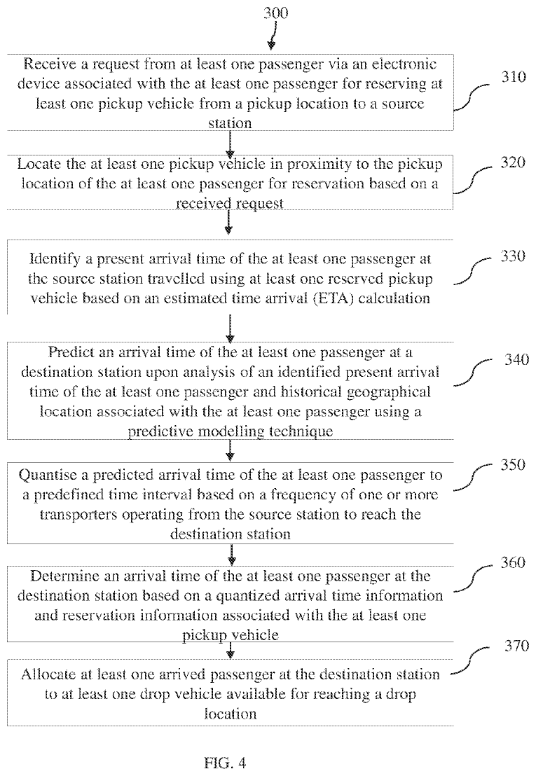

The bus (220) as used herein refers to be internal memory channels or computer network that is used to connect computer components and transfer data between them. The bus (220) includes a serial bus or a parallel bus, wherein the serial bus transmit data in bit-serial format and the parallel bus transmit data across multiple wires. The bus (220) as used herein, may include but not limited to, a system bus, an internal bus, an external bus, an expansion bus, a frontside bus. a backside bus and the like. FIG. 4 is a flow chart representing the steps involved in a method to manage first and last mile connectivity service of a trip of FIG. 1 in accordance with the embodiment of the present disclosure. The method (300) includes receiving, by a passenger request receiving subsystem, a request from at least one passenger via an electronic device associated with the at least one passenger for reserving at least one pickup vehicle from a pickup location to a source station in step 310. In one embodiment, receiving the request from the at least one passenger via the electronic device associated with the at least one passenger may include receiving the request from the at least one passenger for the reservation of the at least one pickup vehicle from at least of a metro station, a suburban railway station, a tram station, a bus terminal, a ferry terminal or a combination thereof.

The method (300) also includes locating, by a pickup vehicle location subsystem, the at least one pickup vehicle in proximity to the pickup location of the at least one passenger for reservation based on a received request in step 320. In one embodiment, locating the at least one pickup vehicle in the proximity to the pickup location of the at least one passenger for the reservation may include locating the at least one pickup vehicle by creating a geo-fence around the pickup location of the at least one passenger dynamically. In some embodiment, locating the at least one pickup vehicle for the reservation may include locating the at least one pickup vehicle based on matching of geographical location coordinates corresponding to the at least one vehicle with geo-fence coordinates corresponding to the at least one passenger.

The method (300) also includes identifying, by a passenger arrival subsystem, a present arrival time of the at least one passenger at the source station travelled using at least one reserved pickup vehicle based on an estimated time arrival (ETA) calculation in step 330. In one embodiment, identifying the present arrival time of the at least one passenger travelled at the source station using the at least one reserved pickup vehicle may include identifying the present arrival time based on a speed by which the at least one pickup vehicle has covered a predefined value of distance. A remaining value of the distance is divided by historical speed value of the at least one pickup vehicle which is previously measured.

The method (300) also includes predicting, by the passenger arrival subsystem, an arrival time of the at least one passenger at a destination station upon analysis of an identified present arrival time of the at least one passenger and historical geographical location associated with the at least one passenger using a predictive modelling technique in step 340. In one embodiment, predicting the arrival time of the at least one passenger upon analysis of the identified present arrival time of the at least one passenger and the historical geographical location associated with the at least one passenger may include predicting the arrival time of the at least one passenger using a machine learning modelling technique. In some embodiment, the historical geographical location data may include at least one of history details of geographical location travelled by the at least one passenger, historical details of geographical location where the at least one passenger took halt, historical details of the geographical location of a frequent arrival point of the at least one passenger and the like.

The method (300) also includes quantising, by the passenger arrival subsystem, a predicted arrival time of the at least one passenger to a predefined time interval based on a frequency of one or more transporters operating from the source station to reach the destination station in step 350. In one embodiment, quantizing the predicted arrival time of the at least one passenger to the predefined time interval may include quantizing the predicted arrival time of the at least one passenger to one or more minutes based on a frequency of one or more transporters operating from the source station. In some embodiment, the one or more transporters may include at least one of a metro, a suburban rail, a tram, a bus, a motorboat or a combination thereof. In some embodiment, the predefined time interval may include one or more minutes in order to improve location accuracy, time of a handheld device associated with the at least one passenger and assignment of at least one drop vehicle for allocation.

The method (300) also includes determining, by the passenger arrival subsystem, an arrival time of the at least one passenger at the destination station based on a quantized arrival time information and reservation information associated with the at least one pickup vehicle in step 360. In one embodiment, determining the arrival time of the at least one passenger at the destination station based on the quantized arrival time information and the reservation information such as at least one of a passenger name, passenger contact number, details of at least one reserved pickup vehicle, driver details of the at least one reserved vehicle and the like.

The method (300) also includes allocating, by a passenger allocation subsystem, at least one arrived passenger at the destination station to at least one drop vehicle available for reaching a drop location in step 370. In one embodiment, allocating the at least one arrived passenger at the destination station to the at least one drop vehicle for reaching the drop location may include allocating the at least one arrived passenger based on the quantized arrival time of the at least one passenger. In some embodiment, allocating the at least one arrived passenger to the at least one drop vehicle may include allocating the at least one arrived passenger using a geo-location modelling technique upon identification of the number of the at least one drop vehicle available and identification of the at least one passenger available at the destination station. In such embodiment, the passenger allocation subsystem may also regroup the at least one arrived passenger at the destination station based on a determined drop location corresponding to the at least one arrived passenger for separating a direction of travel upon allocation.

In a specific embodiment, the method (300) further includes managing, by a vehicle management subsystem, an availability of the at least one pick up vehicle and the at least one drop vehicle for providing a transportation service based on historical usage data and a predicted weather forecast report.

Various embodiments of the present disclosure provide quantized prediction of the arrival time of the passengers based on recent location history of the passengers to match with the frequency of trains which helps in optimizing a process of missing the trains.

Moreover, the present disclosed system utilizes geo information to group the passengers travelling to similar direction from given source and as a result helps in better management of allocating the one or more vehicles from a transporter station.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (100) to manage first and last mile connectivity service of a trip comprising:
a passenger request receiving subsystem (110) configured to receive a request from at least one passenger via an electronic device associated with the at least one passenger for reserving at least one pickup vehicle from a pickup location to a source station;
a pickup vehicle location subsystem (120) operatively coupled to the passenger request receiving subsystem (110), wherein the pickup vehicle location subsystem (120) is configured to locate the at least one pickup vehicle in proximity to the pickup location of the at least one passenger for reservation based on a received request;
a passenger arrival identification (130) subsystem operatively coupled to the vehicle location subsystem (120), wherein the passenger arrival identification subsystem (130) is configured to:
identify a present arrival time of the at least one passenger at the source station travelled using at least one reserved pickup vehicle based on an estimated time arrival (ETA) calculation;
predict an arrival time of the at least one passenger at a destination station upon analysis of an identified present arrival time of the at least one passenger and historical geographical location data associated with the at least one passenger using a predictive modelling technique;
quantize a predicted arrival time of the at least one passenger to a predefined time interval based on a frequency of one or more transporters operating from the source station to reach the destination station;
determine an arrival of the at least one passenger at the destination station based on a quantized arrival time information and reservation information associated with the at least one pickup vehicle; and
a passenger allocation subsystem (140) operatively coupled to the passenger arrival identification subsystem (130), wherein the passenger allocation subsystem (140) is configured to allocate at least one arrived passenger at the destination station to at least one drop vehicle available for reaching a drop location.

2. The system (100) as claimed in claim 1, wherein the pickup vehicle location subsystem (120) is configured to create a geo-fence around the pickup location of the at least one passenger dynamically.

3. The system (100) as claimed in claim 1, wherein the pickup vehicle location subsystem (120) is configured to locate the at least one pickup vehicle for the reservation based on matching of geographical location coordinates corresponding to the at least one pickup vehicle with geo-fence coordinates corresponding to the at least one passenger.

4. The system (100) as claimed in claim 1, wherein the passenger allocation subsystem (140) is configured to identify number of the at least one drop vehicle available at the destination station in real-time for allocation of the at least one arrived passenger based on the quantized arrival time of the at least one passenger.

5. The system (100) as claimed in claim 1, wherein the passenger allocation subsystem (140) is configured to determine the drop location corresponding to the at least one arrived passenger using a geo-location modelling technique upon identification of the number of the at least one drop vehicle available and identification of the at least one passenger available at the source station.

6. The system (100) as claimed in claim 1, wherein the passenger allocation subsystem (140) is configured to regroup the at least one arrived passenger at the destination station based on a determined drop location corresponding to the at least one arrived passenger upon allocation for separating a direction of travel.

7. The system (100) as claimed in claim 1, further comprising a vehicle management subsystem (150) operatively coupled to the passenger arrival identification subsystem (130), wherein the vehicle management subsystem (150) is configured to manage an availability of the at least one pick up vehicle and the at least one drop vehicle for providing a transportation service based on historical usage data and a predicted weather forecast report.

8. A method (300) comprising:
receiving, by a passenger request receiving subsystem, a request from at least one passenger via an electronic device associated with the at least one passenger for reserving at least one pickup vehicle from a pickup location to a source station (310);
locating, by a pickup vehicle location subsystem, the at least one pickup vehicle in proximity to the pickup location of the at least one passenger for reservation based on a received request (320);
identifying, by a passenger arrival identification subsystem, a present arrival time of the at least one passenger at the source station travelled using at least one reserved pickup vehicle based on an estimated time arrival (ETA) calculation (330);
predicting, by the passenger arrival identification subsystem, an arrival time of the at least one passenger at a destination station upon analysis of an identified present arrival time of the at least one passenger and historical geographical location associated with the at least one passenger using a predictive modelling technique (340);
quantizing, by the passenger arrival identification subsystem, a predicted arrival time of the at least one passenger to a predefined interval of time based on a frequency of one or more transporters operating from the source station to reach a destination station (350);
determining, by the passenger arrival identification subsystem, an arrival time of the at least one passenger at the destination station based on a quantized arrival time information and reservation information associated with the at least one pickup vehicle (360); and
allocating, by a passenger allocation subsystem, at least one arrived passenger at the destination station to at least one drop vehicle available for reaching a drop location (370).

9. The method (300) as claimed in claim 8, further comprising, managing, by a vehicle management subsystem, an availability of the at least one pick up vehicle and the at least one drop vehicle for providing a transportation service based on historical usage data and a predicted weather forecast report.
